(19) United States
(12) Patent Application Publication
(10) Pub. No.: US 2012/0052238 A1
(43) Pub. Date: Mar. 1, 2012

(54) FIRE-RESISTANT PRINT BOARD

(75) Inventor: Scott David Daniel, Vernon Hills, IL (US)

(73) Assignee: Pregis Innovative Packaging, Inc., Deerfield, IL (US)

(21) Appl. No.: 12/873,767

(22) Filed: Sep. 1, 2010

(51) Int. Cl. B32B 3/12; B32B 3/28; B32B 37/00; B32B 9/06

(52) U.S. Cl. 428/116; 428/452; 428/182; 428/332; 156/60

(57) ABSTRACT

A composite print board composite structure is disclosed, including a fire-resistant layer of paper material having a fire-resistant compound associated with the paper material to provide fire resistance, and a printable layer of paper material coated with clay, adhered to the fire-resistant layer on an opposite side from the core layer, the mineral substance providing a printable surface. A core layer of a low-density, honeycomb or corrugated configuration, is optionally included.

### TECHNICAL FIELD

The present disclosure relates generally to composite structures used to fabricate articles for the storage, display, and/or transportation of retail products. More particularly, the present disclosure relates to such composite structures having fire-resistant properties.

### BACKGROUND

Articles for product storage, display, and shipping purposes are typically designed to be sufficiently durable to allow reliable use of such materials. Considerations that are taken into account in the development of such articles, and materials which comprise their composite structure include their resistance to tearing, wrinkling, scuffing, and moisture. Their load and tear strength are also considered. The composite structures are also desirably relatively inexpensive to manufacture, and are preferably attractive enough to the customer in appearance, print quality, feel, and touch to encourage use of the products as well as to enhance the product image or association.

A configuration that is often used for shipping and/or retail applications include corrugated boards that are durable and readily machinable, for example by automated scoring, folding, bending, die-cutting, and even cartoning, to form a desired shape. Unfortunately, many paperboard materials used to form such packages often do not have a surface that lends itself to high quality printing, with the result that the paperboard structures created therefrom often have an unrefined and industrial look that can be unattractive to consumers. Additionally, paperboard structures have little or no resistance to heat, fire, tearing, wrinkling, and scuffing.

Accordingly, there remains a need in the art for storage, retail and/or shipping composite articles that are durable and cost effective while also being attractive to consumers in terms of appearance and touch. There is also a need to provide packages having a good printing surface so that more attractive product and marketing information and labels may be formed on the article. Additionally, there remains a need in the art for such articles that have fire resistant properties for safety considerations.

### SUMMARY

In one embodiment, disclosed herein is a print board composite structure including a fire-resistant layer of paper material having a fire-resistant compound associated with the paper material to provide fire resistance, and a printable layer of paper material coated with clay, adhered to the fire-resistant layer on an opposite side from the core layer, with the mineral substance providing a printable surface.

The print board may include a core layer associated with the fire resistant layer for providing bending stiffness. The core layer may be a honeycomb structure or a corrugated structure of a fiber-based material. The fire-resistant compound may be an acid/ammonium phosphate based compound that is impregnated in the paper material of the fire-resistant layer to provide fire resistance. The mineral substance may be a clay receptive to the application of ink or pigments. Additionally, the layers may be adhered with fire-resistant glue.

In an alternative embodiment, disclosed is composite print board, including a core layer of low-density paper material, a fire-resistant layer of paper material having a fire-resistant compound, the fire-resistant layer being adhered to the core layer, and a printable layer of paper material having a mineral substance coated thereon, adhered to the fire-resistant layer on an opposite side from the core layer, the mineral substance providing a printable surface. The core layer and the fire-resistant layer may be associated to provide bending stiffness to the print board.

The core layer of the print board may be arranged in a configuration such that it comprises at least about 75% air space. The core layer may also include a fire-resistant compound for added fire protection. This embodiment may further include a layer of paper material on the opposite side of the core layer from the fire-resistant layer.

While multiple embodiments are disclosed, still other embodiments of the present disclosure will become apparent to those skilled in the art from the following detailed description, which shows and describes illustrative embodiments. As will be realized, the invention is capable of modification in various aspects, all without departing from the spirit and scope of the present disclosure. Accordingly, the drawings and detailed descriptions are to be regarded as illustrative in nature, and not restrictive.

### BRIEF DESCRIPTION OF THE FIGURES

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 is a side view of an embodiment of a print board constructed in accordance with the present disclosure;

FIG. 2a is a perspective view of the print board of FIG. 1;

FIG. 2b is a cross-section view of the honeycomb core of the print board viewed along line IIb-IIb of FIG. 2A;

FIGS. 3A-3E are perspective views of alternative embodiments of core configurations suitable for use with various embodiments of print boards disclosed herein;

FIG. 4 is a side view of another embodiment of a print board having two fire-resistant layers; and

FIG. 5 is a side view of another embodiment of a print board having a clay layer separately adhered to the fire-resistant layer.

FIG. 6 is a block diagram of a method in accordance with the present disclosure.

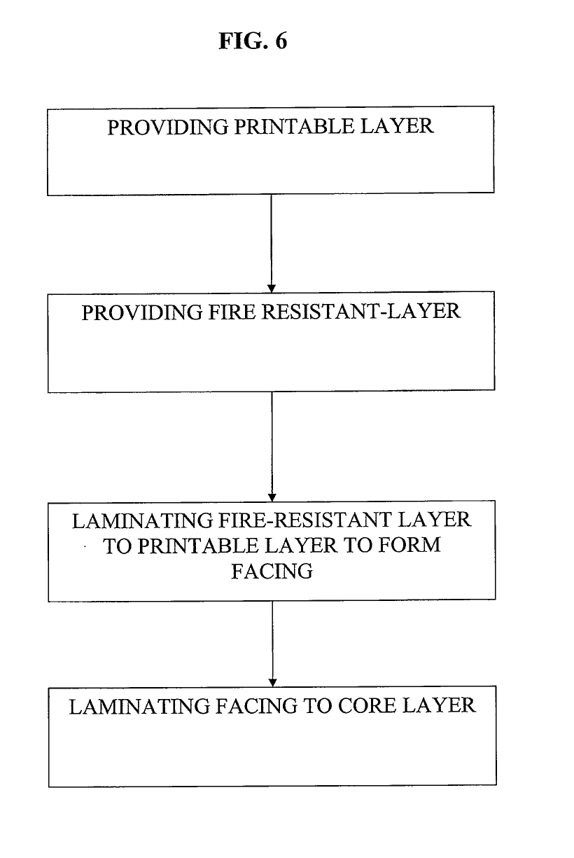

### DETAILED DESCRIPTION

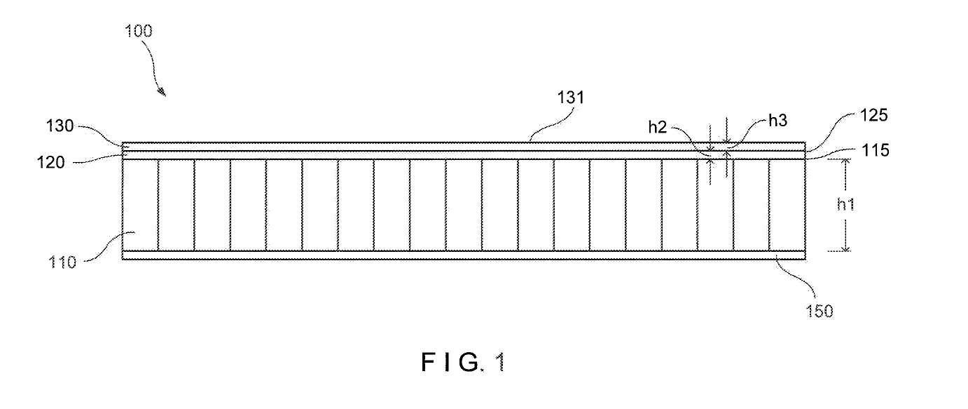

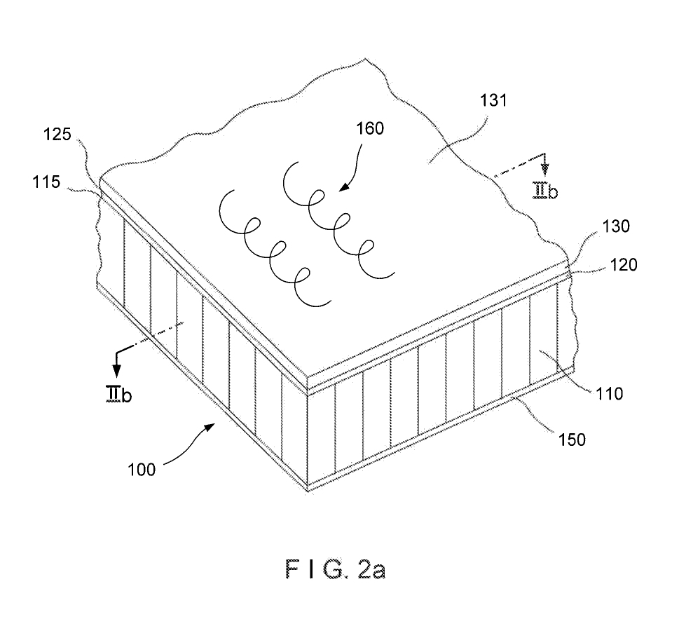

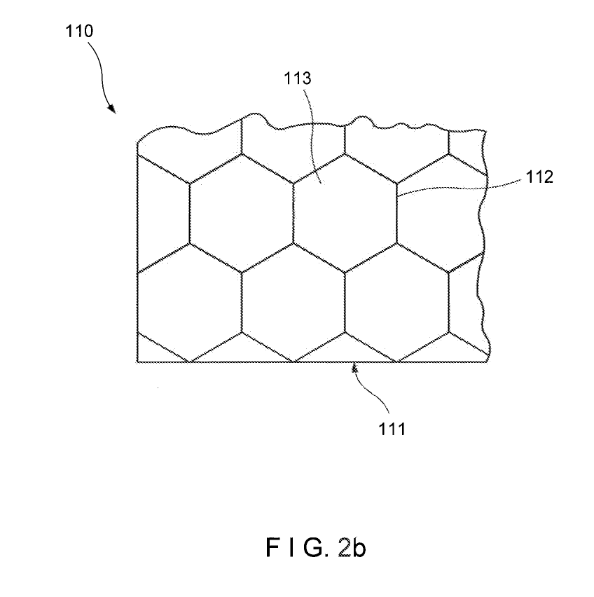

In one embodiment, as shown in FIGS. 1 and 2A-B, a print board composite structure 100 is depicted having three layers: a core layer 110, a fire-resistant layer 120, and a printable layer 130, the layers being adhered or laminated to one another. The layers 110, 120, and 130 may generally be made of a fiber-based material, such as paper or paper-board, as will be discussed in greater detail below.

The core layer 110 internal configuration, as shown by a broken up top cross-sectional view of the core layer 110 along line V-V as shown in FIG. 2B, comprises a honeycomb structure 111. The honeycomb structure 111 can have walls 112. The honeycomb structure can have cells of six walls 112 as shown in FIG. 2B, having a hexagonal shape, or can alternatively an octagonal shape, or a shape with more or less sides, such as 3-4 sides. Because of the ease of working with paper materials and the availability of various honeycomb structures, products can be manufactured in a variety of shapes and sizes to meet any particular requirements. Exemplary honeycomb cores 110 which may be used with the present disclosure include those which are produced under the Hexacomb® brand by Pregis Corporation.

The honeycomb structure 111 can provide for plenty of air spaces 113 within or in between the walls 112 to provide for a low-density honeycomb material. For example, the core layer 110 can comprise a material having over 60%, 70%, or 90% airspace, although any amount of airspace may be acceptable. In other embodiments, a corrugated or other low-density structure may be used in place of the honeycomb structure. The core layer 110 may generally be made of any fiber or paper-based material. The core layer 110 may be preferably made of 23 lb.-42 lb. base weight core paper, and most preferably 31 lb. basis weight core paper. The use of paper materials can be cost competitive to materials such as wood, metal, and plastic, while at the same time offering benefits that are not available through the use of traditional wood materials. Paper products can be made lighter than wood, plastic, or metal products, and when formed into a honeycomb structure may have remarkable strength, including increased bending stiffness over other configurations.

The fire-resistant layer 120 may generally be made of a fiber-based or paper material with a fire-resistant substance impregnated thereon. The paper material may preferably have a density between approximately 26 lb./1000 sq. ft.-150 lb./sq. ft., and most preferably the paper material may have a density of 56 lb./1000 sq. ft. The paper material of fire-resistant layer 120 may generally be made with a material having less than 25% airspace, and preferably less than 10% airspace. The paper material of layer 120 is preferably made of a single sheet, but may be made of multiple plies, for instance.

The fire-resistant substance impregnated on the paper material of layer 120 may generally be any substance which is flame retardant, flame resistant, or otherwise suppresses, slows, or mitigates the propagation of flame, or prevents inflammability upon the application of heat or flame thereto when applied to, adhered to, or otherwise physically associated with another material that would, without such flame resistant substance, be prone to flammability. In one embodiment, the flame resistant substance may preferably comprise a mixture of water, sulfamic acid, diammonium phosphate, orthoboric acid, and sodium 2-ethylhexyl sulfate ester. The preferred volumetric proportions of these components in the fire-resistant substance is preferably no less than about 35-45%, 45-55%, 10-20%, 5-15%, and 0.5-5% of the mixture, respectively, and most preferably less than about 40%, 50%, 15%, 10%, and 2% of the mixture, respectively. Such a preferred fire-resistant substance is manufactured under the trade name PyroBreak EX-18 ®, by Pyrotech, Inc. As will be appreciated by those of skill in the art, other fire-resistant substances, and in particular phosphate-based fire-resistant substances, may be impregnated on the paper material of layer 120 as well.

In further embodiments, the core layer may also have a fire-resistant substance impregnated thereto or applied thereon, in a manner as described above with regard to the fire-resistant layer of paper material.

The printable layer 130 may generally be made of a fibrous or paper material with a mineral or clay substance 131 coated thereon, preferably only on one side of the paper material. A preferred paper material is a groundwood-based paper. Alternatively, the printable layer may include just a layer or the mineral or clay without being coated on a paper substrate. The paper material may preferably have a density between approximately 25 lb./1000 sq. ft.-150 lb./sq. ft., more preferably between about 30 lb./sq. ft.-75 lb./sq. ft., and most preferably the paper material may have a density of about 38 lb./sq. ft. The paper material of printable layer 130 may generally be made with a material having less than 25% airspace, and preferably less than 10% airspace, and most preferably less than 5% airspace. The paper material of layer 130 is preferably made of a single sheet, but may be made of multiple plies, for instance.

The mineral or clay substance coated on the paper material may consist of several components. These include pigments, for example, which form the color component of the coating. The percentage of pigment in color component of the coating may be generally from 50%-95% by weight, 70%-95% by weight, or most preferably about 85%-95% by weight. Pigment may be of any color. Typically, the particle size of a pigment is less than about 10 μm. Typical minerals used in such coatings may include kaolin clay or calcium carbonate, among various others. Such mineral or clay may be receptive to the application of ink or pigments, or any other substances used in printing, such that when such ink or pigment is applied to the clay, it provides a substrate that fixes the ink or pigment in the manner, form, and shape applied. As shown in FIG. 2A, printed matter 160 is present on the clay coating 131.

The type of clay or other mineral 131 applied to the paper generally depends on the printable qualities desired. For example, the qualities of brightness and gloss level and standard parameters for such clay or mineral coated papers. Depending on the application, various levels of gloss and brightness may be desired, which will in turn dictate the type of clay applied, as will be appreciated by those skilled in the art. Suitable clay coated papers may by obtained from Meadwestvaco Corporation, among others. Typically, for printing applications, the clay may be white in color, although any color of clay, including clays with colorings added, are within the scope of this disclosure. Various adhesives can be used between the layers 110, 120 and 130 to adhere the layers to one another, such as, but not limited to PVA glue, EVA glue, water based adhesives, starch based adhesives, HotMelt®, and solventless adhesives. Preferred embodiments may utilize PVA glue. Alternatively, Flame Resistance Glue may be used for additional flame-resistant properties. Preferably, glues other than solvent or hydrocarbon-based glues, which are typically flammable, are used, although any glue or adhesives may be used.

An additional layer of fiber-based or paper material 150 is applied to the side opposite the core layer 110 from the fire resistant layer, as depicted in FIGS. 1-2A. Such additional layer 150 may provide protection to the opposite face of the core structure, which, without such protection, may be susceptible to damage or crushing in ordinary use. Further, such layer may also provide increased bending stiffness to the board. The layer 150, in some embodiments, may have a fire-resistant substance applied thereto, as discussed above with regard to layer 120, or it may have a clay coating or mineral layer applied thereto, as discussed above with regard to layer 130. Of course, multiple protective layers 150 may be applied to the core layer 110, in any form or configuration.

The layers 110, 120, and 130 can have an adjacent, overlapping orientation as shown in FIGS. 1 and 2A. Preferably the layers 110, 120, and 130 are coextensive and are adhered as a single thick sheet of layered material in the finished print board. Core layer 110 may be adjacent to fire-resistant layer 120, while fire resistant layer 120 may be adjacent to core layer 110 and printable layer 130. Thus, printable layer 130 may be adjacent to fire resistant layer 120, and the clay coating 131 of printable layer 130 may face outward such that any printed material thereon may be visible. In the embodiment show, core layer 110 is substantially thicker than fire-resistant layer 120 and printable layer 130. Although, each layer can have a similar or substantially similar thickness, or have different thicknesses. In a preferred embodiment, as shown in FIG. 1, the thickness t1 of core layer may be between about 0.1-10 inches, or preferably between about 0.2-6 inches; the thickness t2 of layer 120 may be between about 0.005-0.070 inches, or preferably between about 0.007-0.05 inches; and the thickness of layer 130 may be between 0.004 and 0.016 inches, more preferably between 0.006 and 0.009 inches, and in one embodiment is 0.0075 inches. can be greater than the thickness t1 of layer 22 and thickness t3 of layer 28. In some embodiments, the thickness of all three layers can be the same, or can vary as required. It will be appreciated that any thicknesses, t1, t2, t3 may be used.

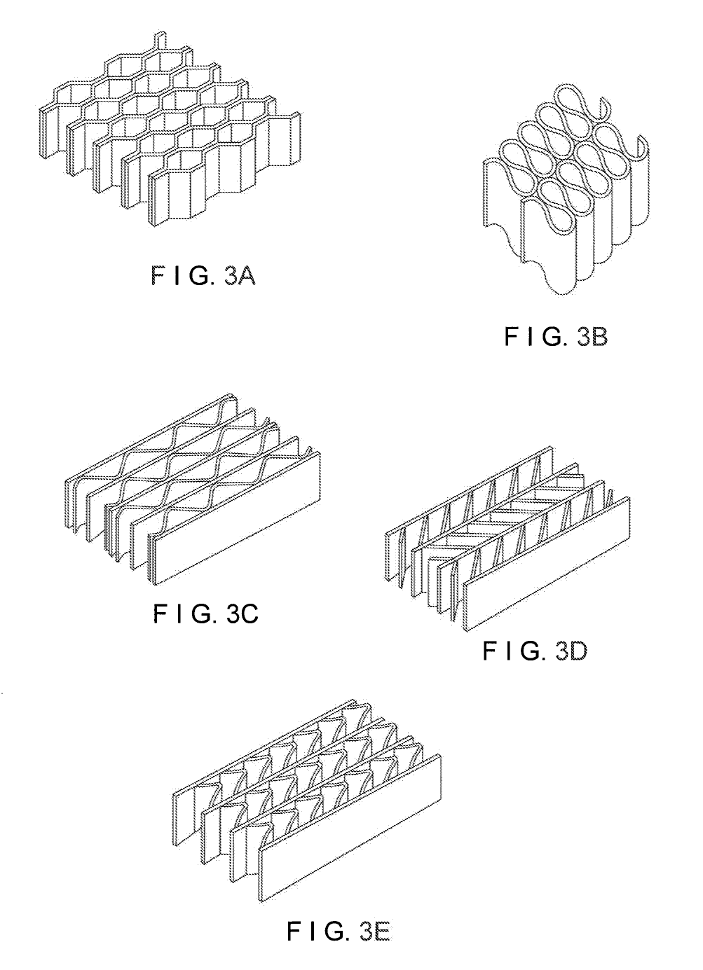

FIGS. 3A-3E depict alternative embodiments of a core layer 110 suitable for use with the print board composite structure 100 of the present disclosure. FIG. 3A depicts the honeycomb structure as discussed above with regard to FIGS. 1-2B. FIG. 3B depicts an hour-glass configuration with the core material curved with respect to each other and adjacent at tangent points of such curves. FIGS. 3C-3E depict corrugated configurations, different with respect to the orientation of the core material between the walls which for the corrugated configuration. The corrugated configuration shown in FIG. 3C is known as a “verticel” configuration. In FIG. 3C, such orientation is V-shaped perpendicular to the walls, while in FIG. 3E, it is V-shaped parallel to the walls. In FIG. 3D, the orientation is parallel intermediate rows, angled with respect to the walls.

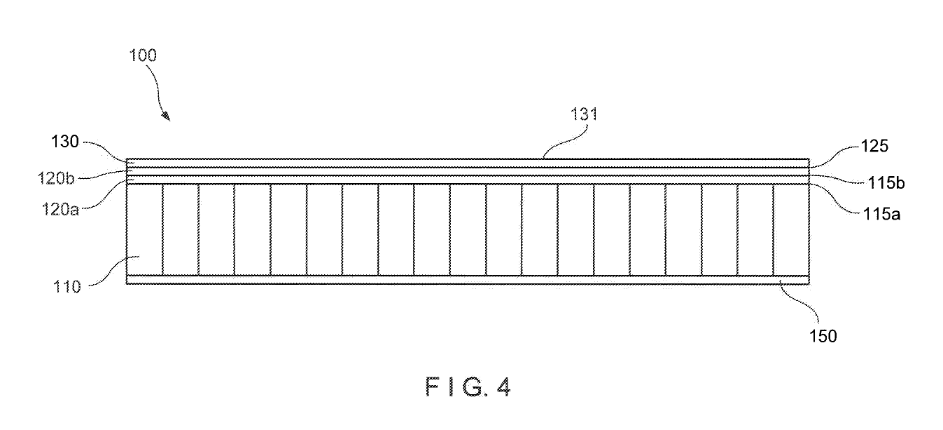

FIG. 4 depicts an alternative embodiment of the presently disclosed print board composite structure having two fire resistant layers. As shown, layers 120a and 120b comprise fire-resistant layers, and described above with respect to layer 120 in FIGS. 1-2A. Adhesive layers 115a and 115b are provided between the core layer 110 and the first fire-resistant layer 120a, and between the first and second fire resistant layers 120a, 120b, respectively. Fire resistant layers 120a, 120b may be of similar or different thicknesses t2, as discussed above, and may comprise any of the fire resistant substances and materials discussed above.

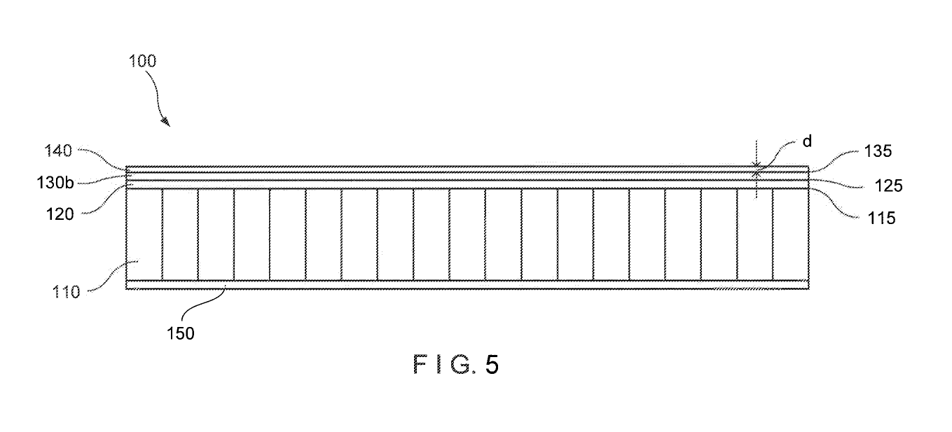

FIG. 5 depicts an alternative embodiment of the presently disclosed print board composite structure wherein the clay comprises a separate layer 140, which is applied to a paper layer 130b. Paper layer 130b is similar to printable layer 130, except that clay does not come applied thereon. Rather, paper layer 130b includes only the paper as discussed above with regard to the printable layer 130 of FIGS. 1-2A. The clay layer 140 may be applied to the surface of layer 130b either before or after the layer 130b has been applied and adhered to the fire-resistant layer 120. The clay layer 140 may be applied in a spray-on fashion, or it may be applied by means of a carrier film which is in turn applied and adhered to paper layer 130b. Other methods of application of clay known in the art are also within the scope of the disclosure. The clay layer 140 may be applied, such as to a density d of between 1 lb./1000 sq. ft. and 7 lb./1000 sq. ft., more preferably between about 2 lb./1000 sq. ft.-5 lb./1000 sq. ft., which in preferred embodiments is approximately 3 lb./1000 sq. ft.

As will be appreciated by those of skill in the art, the fire resistant layer 120 and the printable layer 130 may be applied to both sides of the core layer 110, rather than just to a single side as shown in the figures. Multiple layers may be applied in any suitable number, orientation, and configuration to suit the purposes of the composite structure. Alternatively, some or all of the layers 110, 120, 130, 131, 140, and/or 150 may not be present. For example, some embodiments may not employ a layer 150 to protect the opposite side of the core layer 110.

In preferred embodiments, a printable layer having clay coating pre-coated thereon is laminated to one or more fire-resistant layers to form a composite facing layer. This composite facing layer is thereafter laminated to a core layer, on one or both sides of the core layer. Embodiments with the composite facing layer on one side of the core may generally be referred to as single-faced composite structures, whereas embodiments having composite facing layers on both sides of the core may generally be referred to as double-faced composite structures.

A particular benefit of the print-board of the present disclosure is that, being made of paper or fiber materials generally, it can be made biodegradable to allow for disposal without penalty charges or prohibitions from land fills or they can be baled and recycled to paper companies. Because of the ease of working with paper materials and the availability of various honeycomb structures, products can be manufactured in a variety of shapes and sizes to meet any particular requirements. Print boards may be used for signage, display shelving, trade show booths, ceiling tiles, office furniture panels, and in store displays.

Although the present disclosure has been described with respect to various embodiments, persons skilled in the art will recognize that changes may be made in form and in detail without departing from the spirit and scope of the present disclosure.

As used herein, the terms “front,” “back,” and/or other terms indicative of direction are used herein for convenience and to depict relational positions and/or directions between the parts of the embodiments. It will be appreciated that certain embodiments, or portions thereof, can also be oriented in other positions.

In addition, the term “about” should generally be understood to refer to both the corresponding number and a range of numbers. In addition, all numerical ranges herein should be understood to include each whole integer within the range. While an illustrative embodiment of the invention has been disclosed herein, it will be appreciated that numerous modifications and other embodiments may be devised by those skilled in the art. Therefore, it will be understood that the appended claims are intended to cover all such modifications and embodiments that come within the spirit and scope of the present invention.

What is claimed is:

1. A composite print board, comprising:
a fire-resistant layer of paper material having a fire-resistant compound associated with the paper material to provide fire resistance; and
a printable layer of paper material coated with clay, adhered to the fire-resistant layer on an opposite side from the core layer, the mineral substance providing a printable surface.

2. The composite print board of claim 1, further comprising a core layer associated with the fire resistant layer for providing bending stiffness.

3. The composite print board of claim 2, wherein the core layer comprises a honeycomb structure or a corrugated structure of a fiber-based material.

4. The composite print board of claim 1, wherein the fire-resistant compound is an acid/ammonium phosphate based compound that is impregnated in the paper material of the fire-resistant layer to provide fire resistance.

5. The composite print board of claim 4, wherein the fire-resistant compound comprises sulfamic acid and ammonium or diammonium phosphate.

6. The composite print board of claim 1, wherein the mineral substance comprises a clay receptive to the application of ink or pigments.

7. The composite print board of claim 1, wherein the layers are adhered with fire-resistant glue.

8. The composite print board of claim 1, wherein the fire-resistant layer comprises a plurality of layers of the fire-resistant paper material.

9. A composite print board, comprising:
a core layer of low-density paper material;
a fire-resistant layer of paper material having a fire-resistant compound, the fire-resistant layer being adhered to the core layer; and
a printable layer of paper material having a mineral substance coated thereon, adhered to the fire-resistant layer on an opposite side from the core layer, the mineral substance providing a printable surface,
wherein the core layer and the fire-resistant layer are associated to provide bending stiffness to the print board.

10. The composite print board of claim 9, wherein the core layer comprises a honeycomb structure.

11. The composite print board of claim 9, wherein the core layer comprises a corrugated structure.

12. The composite print board of claim 9, wherein the core layer further comprises a fire-resistant compound.

13. The composite layer of claim 9, wherein the core layer thickness is between about 0.2 inches-6 inches.

14. The composite layer of claim 9, wherein the core layer is arranged in a configuration such that it comprises at least about 75% air space.

15. The composite layer of claim 9, wherein the fire-resistant layer thickness is between about 0.007 inches-0.050 inches.

16. The composite layer of claim 9, wherein the fire-resistant compound comprises a mixture of water, sulfamic acid, diammonium phosphate, orthoboric acid, and sodium 2-ethylhexyl sulfate ester in volumetric proportions of 30-50%, 40-60%, 10-20%, 5-20%, and 0.5-5%, respectively.

17. The composite layer of claim 9, wherein the mineral layer thickness is about 3 lb./1000 sq. ft.

18. A method for forming a facing for a composite print board, comprising:
providing a printable layer of paper material having a mineral substance coated thereon;
providing a fire resistant layer of paper material having a fire-resistant compound impregnated thereon;
laminating the printable layer to the fire-resistant layer.

19. The method of claim 18, further comprising forming a single-faced composite print board by laminating the facing to single side of a core layer of low density paper material.
